(19) United States
(12) Patent Application Publication
(10) Pub. No.: US 2020/0317573 A1
(43) Pub. Date: Oct. 8, 2020

(54) MULTIFUNCTIONAL TITANIUM DIOXIDE-POLYMER HYBRID MICROCAPSULES FOR THERMAL REGULATION AND VISIBLE LIGHT PHOTOCATALYSIS

(71) Applicant: Nanyang Technological University, Singapore (SG)

(72) Inventors: En-Hua YANG, Singapore (SG); Aiqin ZHAO, Singapore (SG); Jinglei YANG, Singapore (SG)

(73) Assignee: Nanyang Technological University, Singapore (SG)

(21) Appl. No.: 16/464,163

(22) PCT Filed: Nov. 29, 2017
(86) PCT No.: PCT/SG2017/050584

§ 371 Date: May 24, 2019

(30) Foreign Application Priority Data
Nov. 29, 2016 (SG) 10201610024U

(51) Int. Cl. C04B 20/12; C09K 5/06; B01J 27/135; B01J 35/00; B01J 37/02; B01J 13/14; B01J 13/22; B01D 53/88

(52) U.S. Cl. CPC C04B 20/123; C09K 5/063; B01J 27/135; B01J 35/004; C04B 2103/0071; B01J 13/14; B01J 13/22; B01D 53/885; B01J 37/0221

(57) ABSTRACT

Disclosed herein are phase change materials microencapsulated by a microcapsule having two shells, the first shell (directly encapsulating the phase change material) being an organic polymeric material and the second shell (an outer shell) being made from a doped TiO₂ material. The microcapsules disclosed herein may be particularly useful for improving the energy efficiency of indoor environments, as well as providing compositions that they are applied to (e.g. paints) with self-cleaning properties.

### FIELD OF INVENTION

The current invention relates to multifunctional titanium dioxide-polymer hybrid microcapsules containing a phase change material that possess visible light photocatalytic properties. The materials disclosed herein may be particularly suited for use in the interior of buildings to help regulate the temperature of the indoor environment because they possess: the ability to self-clean surfaces; the ability to scrub air of contaminants; and anti-bacterial properties. These latter three abilities arise from the visible light photocatalytic activity of the disclosed microcapsules.

### BACKGROUND

The listing or discussion of a prior-published document in this specification should not necessarily be taken as an acknowledgement that the document is part of the state of the art or is common general knowledge.

In recent years, the use of thermal energy storage (TES) with latent heat storage has become a very popular topic of research and development. The main advantage of latent heat storage is that a high storage density can be achieved within a small temperature interval or window. As such, these materials have significant potential applications in relation to buildings.

However, in most cases the materials used to provide the latent heat storage is a phase change material (PCM), which materials cycles between two phases (e.g. liquid to gas or, more typically, from solid to liquid). As will be appreciated, these phase change materials need to be encapsulated to avoid leakage and loss of the material (e.g. when the material is in the liquid or gas phases). One set of techniques used to encapsulate such phase change materials is microencapsulation, which results in microcapsules—that is, particles that are smaller than 1 mm in diameter. Microencapsulation serves several purposes, such as:
retaining the PCM when it is in the liquid or gas phase and preventing changes to its composition through contact with the environment;
improving compatibility of the resulting material with the materials surrounding it, through providing a barrier material that improves compatibility; improving the handling of the PCM during production;
reducing external volume change impact;
improving heat transfer to the surroundings through the large surface to volume ratio of the microcapsules; and
improving cycling stability (e.g. between solid-liquid), since phase separation is restricted to microscopic distances.

As depicted in FIG. 1, microencapsulated PCMs 100 are composed of two main parts, the core (the PCM; 120) and the shell (110). The shell may be an organic and/or an inorganic material and acts to at least retain the PCM within the core of the microcapsule. However, it may also provide mechanical strength and compatibility with building materials. As depicted in FIG. 1, the microcapsule may cycle between a form where the PCM is solid (A) and a form where the PCM is in the liquid phase (B). Given this property, the PCM may absorb and release heat depending on the ambient temperature that it is exposed to.

Despite the advantages of Microencapsulated Phase Change Materials (MEPCMs) with an organic shell, their utilization is sometimes restricted due to their flammability, low mechanical properties (e.g. low strength and durability) and low heat conductivity. Some of these drawbacks can be overcome by MEPCMs that have an inorganic shell instead. Silica is considered as an inorganic shell material that has been used to improve the thermal conductivity and phase change performance, due to silica's physical and chemical properties, which include chemical and thermal stability, flame retardant properties, and good compatibility with building materials.

There remains a need for improved MEPCMs materials that are structurally stronger and which may also have further functionality, such as the ability to assist in the self-cleaning of a surface, particularly indoors. Other desirable properties include the ability to scrub air (e.g. remove toxins/contaminants from the air) and/or possess an anti-bacterial effect.

### SUMMARY OF INVENTION

In this invention, core material-PCM as a temperature adjustor, is encapsulated in a doped TiO₂-based microcapsule via interfacial polymerization and electrostatic interaction. In addition, electrostatic force between oppositely charged molecules also plays an important role in formation of the capsule shell. That is, the positively charged and negatively charged molecules in the reaction mixture are attracted to one another via electrostatic force to form a new shell covering the existing capsules.

It has been surprisingly found that microcapsules made from a combination of a polymer and titanium dioxide overcome the above problems and can provide useful self-cleaning, anti-bacterial and air-scrubbing properties indoors using visible light, due to the visible light photocatalytic nature of said materials. Thus, in a first aspect of the invention, there is provided a microcapsule encapsulating a phase change material comprising:
a core encapsulated by a first shell and a second shell, where the first shell is sandwiched between the second shell and the core, wherein:
   the core comprises a phase change material that undergoes a phase change at from 0° C. to 200° C.;
   the first shell is an organic polymeric material; and
   the second shell comprises a doped titanium dioxide.

In embodiments of the first aspect of the invention:

(xa) the phase change material may undergo a phase change at from 5° C. to 150° C.;
(xb) the phase change material may be an organic phase change material (e.g. a C₁₄-C₄₅ paraffinic hydrocarbon (e.g. a C₁₄, C₁₈, C₂₂-C₄₅ hydrocarbon, such as octadecane));
(xc) the titanium dioxide shell may be doped with one or more of the group selected from C, N, F, P, S, I, La, Ce, Er, Pr, Gd, Nd, Sm, V, Fe, Ni, Zn, Os, Ru, Mn, Cr, Co, and Cu (e.g. the titanium dioxide shell may be doped with one or more of the group selected from C, N, and F, optionally wherein the titanium dioxide shell may comprise one or more areas consisting of a TiO₂₋ₓFₓ structure and/or one or more areas consisting of a TiOF₂ structure);
(xd) the microcapsule may have an average size of from 10 μm to 1000 μm, such as from 50 to 500 μm, from 75 μm to 450 μm, or such as from 100 to 400 μm;
(xe) the first shell may have a thickness of from 75 to 250 nm (e.g. from 100 to 200 nm);
(xf) the second shell may comprise a layer of doped titanium dioxide having a thickness of from 0.5 μm to 50 μm (e.g. from 1 μm to 10 μm);
(xg) the core material comprises from 50 to 85 wt % of the microcapsule (e.g. from 65 to 80 wt %, such as 75 wt % of the microcapsule);
(xh) the microcapsule is capable of photocatalysis at visible light wavelengths of from 400 nm to 700 nm (e.g. from 420 to 630 nm).

In embodiments of the first aspect of the invention, the first and second shell together may comprise, when measured by XPS an amount of carbon of from 2 to 40 wt %; an amount of nitrogen of from 2 to 10 wt %; an amount of fluorine of from 8 to 18 wt %; an amount of oxygen of from 17 to 50 wt %; an amount of titanium of from 15 to 45 wt %; and the balance hydrogen or other elements. For example, the first and second shell together may comprise, when measured by XPS an amount of carbon of from 11 to 15 wt %; an amount of nitrogen of from 6 to 10 wt %; an amount of fluorine of from 10 to 15 wt %; an amount of oxygen of from 32 to 40 wt %; an amount of titanium of from 28 to 35 wt %; and the balance hydrogen or other elements. For example, the first and second shell together comprise, when measure by XPS an amount of carbon of 12.90 wt %; an amount of nitrogen of 6.98 wt %; an amount of fluorine of 12.81 wt %; an amount of oxygen of 35.67 wt %; an amount of titanium of 30.62 wt %; and the balance hydrogen or other elements.

Suitable organic polymeric materials may comprise functional groups that are cationic in aqueous media, optionally wherein the functional groups are cationic in aqueous media at a pH of from 2.0 to 6.0, such as from 2.5 to 4.0, such as 3.0. Such suitable organic polymeric materials may comprise: polycationic polymeric materials, such as a polymer selected from the group consisting of polyurea (e.g. a polyurea formed from a polyimine and an organic diisocyanate), melamine-formaldehyde resin, urea-formaldehyde resin, and poly(ethylene glycol-co-chitosan); or a polymeric material with an anionic surface coated with a polycationic polyelectrolyte. Suitable polymeric materials having an anionic surface include acrylic-based polymer comprising free carboxylic acid functional groups (e.g. poly(methyl methacrylate) comprising from 1-20% methacrylic acid monomers), a poly(ethylene glycol-co-cellulose) surface-modified with carboxylic acid functional groups, a polystyrene surface-modified with carboxylic acid functional groups, and cyclic poly(phthalaldehyde) (cPPA) surface-modified with carboxylic acid functional groups. The polycationic electrolyte is selected from the group consisting of polyethyleneimine (PEI), poly-1-lysine (PLL), diethylaminoethyl-dextran (DEAE-dextran), and branched polymers such as poly(amidoamine) (PAMAM) dendrimers.

In particular embodiments of the first aspect of the invention, the organic polymeric material may comprise a polyurea formed by the reaction between hexamethylene diisocyanate and polyethylenimine, optionally wherein the weight average molecular weight of the polyethylenimine is from 800 Daltons to 3,000 Daltons, such as from 1,000 Daltons to 2,000 Daltons, such as 1,300 Daltons.

In a second aspect of the invention, there is provided a composition comprising a microcapsule encapsulating a phase change material as defined in the first aspect of the invention and by any technically sensible combination of its embodiments, wherein the composition is a paint composition, a plaster composition, a gypsum composition, a cement composition or a concrete composition.

In a third aspect of the invention, there is provided a process of making a microcapsule encapsulating a phase change material as defined in the first aspect of the invention and by any technically sensible combination of its embodiments, comprising the steps of:
(a) providing an aqueous emulsion comprising a first polymeric precursor material, a phase change material and a surfactant;
(b) adding a second polymeric precursor material to the aqueous emulsion to form polymeric pre-microcapsules having a core comprising the phase change material and an organic polymeric shell, through the reaction of the first and second polymeric precursor materials together in a polymerisation reaction; and
(c) adding an inorganic monomeric material to the polymeric pre-microcapsules to form an inorganic shell around each polymeric pre-microcapsule under conditions that cause polymerisation of the inorganic monomeric material to provide a microcapsule encapsulating a phase change material, wherein:
the conditions of step (c) cause self-assembly of the inorganic shell on the organic polymeric shell due to attractive electrostatic interactions between the organic polymeric shell and the inorganic monomeric material;
the phase change material undergoes a phase change at from 0° C. to 200° C.; and
the inorganic monomeric material comprises a titanium dioxide precursor material.

In embodiments of the third aspect of the invention:

(aa) the surfactant may be a non-ionic surfactant (e.g. the non-ionic surfactant may be selected from one or more of the group consisting of arabic gum polyethylene oxide lauryl ether 30, sorbitan oleate, sorbitan 80, and polyoxyethylene sorbitol monooleate 80 mixture);
(bb) the phase change material may undergo a phase change at from 5° C. to 150° C.;
(cc) the phase change material may be an organic phase change material (e.g. the organic phase change material may be a C₁₄-C₄₅ paraffinic hydrocarbon (e.g. a C₁₄, C₁₈, C₂₂-C₄₅ paraffinic hydrocarbon, such as octadecane));
(dd) the inorganic monomeric material may be a titanium dioxide precursor (e.g. (NH₄)₂TiF₆);
(ee) the microcapsule provided in step (c) may have an average size of from 10 to 1000 μm, such as from 50 to 500 μm, from 75 to 450 μm, such as 100 to 400 μm;
(ff) the organic polymeric shell may have a thickness of from 75 to 250 nm (e.g. from 100 to 200 nm);
(gg) the inorganic shell comprises a layer of the polymerised inorganic monomeric material which may have a thickness of from 0.5 μm to 50 μm (e.g. from 1 μm to 10 μm);
(hh) the phase change material comprises from 50 to 85 wt % of the microcapsule (e.g. from 65 to 80 wt %, such as 75 wt % of the microcapsule).

In embodiments of the third aspect of the invention, the first and second polymeric precursor materials, following reaction together, may provide an organic polymeric material comprising functional groups that are cationic in aqueous media, optionally wherein the functional groups are cationic at a pH of from 2.0 to 6.0, such as from 2.5 to 4.0, such as 3.0. For example:
(A) the first polymeric precursor material may be an organic diisocyanate and the second polymeric precursor material may be a polyimine, optionally wherein the first polymeric precursor material may be hexamethylene diisocyanate and the second polymeric precursor material may be a polyethylenimine (e.g. the weight average molecular weight of the polyethylenimine may be from 800 Daltons to 3,000 Daltons, such as from 1,000 Daltons to 2,000 Daltons, such as 1,300 Daltons);
(B) the first polymeric precursor material may be melamine and the second polymeric precursor material may a formaldehyde;
(C) the first polymeric precursor material may be an organic diisocyanate and the second polymeric precursor material may be a formaldehyde;
(D) the first polymeric precursor material may be ethylene oxide and the second polymeric precursor material may be a chitosan;
(E) the first polymeric precursor material may comprise a mixture of an acrylic acid and an alkyl acrylate monomer (e.g. methyl methacrylate) and the second polymeric precursor material may be a radical initiator, which process further comprises after step (b) and before step (c), adding a polycationic electrolyte to the polymerised material to form a polycationic electrolyte coating layer on the surface of the organic polymeric shell.

In further embodiments of the third aspect of the invention:
(i) the first polymeric precursor material may be ethylene oxide and the second polymeric precursor material is a cellulose acetate;
(ii) the first polymeric precursor material is styrene and the second polymeric precursor material is a radical initiator; or
(iii) the first polymeric precursor material is phthalaldehyde and the second polymeric precursor material is an acid or a base; and
the process may further comprise after step (b) and before step (c), the steps of:
(aaa) grafting carboxylic functional groups onto the surface of the organic polymeric shell to form an anionic surface; and
(bbb) adding a polycationic electrolyte to the anionic surface of the organic polymeric shell.

In yet further embodiments of the third aspect of the invention, in step (a) of said process, the aqueous emulsion comprising a first polymeric precursor material that is water-immiscible, a phase change material and a surfactant may be provided by:
(I) providing an aqueous solution of a surfactant under stirring at a stirring speed of from 200 to 4000 RPM (e.g. from 600 to 2000 RPM, such as 800 to 1500 RPM); and
(II) providing a mixture of the first polymeric precursor material and the phase change material and adding it to the stirred aqueous solution of the surfactant. In certain embodiments, step (II) may be conducted at a temperature of from 30 to 60° C., such as 50° C.

In yet further embodiments of the third aspect of the invention:
(az) step (b) of the process may be conducted at a temperature of from 30 to 60° C., such as 50° C.; and/or
(bz) step (c) of the process may be conducted at a pH of from 2.0 to 6.0, such as from 2.5 to 4.0, such as 3.0; and/or
(cz) step (c) of the process may be conducted at a temperature of from 25 to 60° C., such as 50° C.

It is contemplated that any technically sensible combination of the embodiments of the third aspect of the invention form part of the scope of this invention.

In a fourth aspect of the invention, there is provided a method of self-cleaning a surface made of a composition according to the second aspect of the invention, said method comprising providing a surface made of a composition according to the second aspect of the invention that has been contaminated with a foreign material and exposing said surface to visible light, optionally wherein said surface is in the interior of a container.

In a fifth aspect of the invention, there is provided a method of scrubbing air with a composition comprising microcapsules according to the first aspect of the invention, said method comprising contacting the composition with air that has been contaminated with a foreign material and exposing the composition to visible light, optionally wherein the composition is within the interior of a container.

### DRAWINGS

FIG. 1 depicts a microencapsulated PCM cycling between a solid and liquid phase.

FIG. 2: (a) shows the typical scanning electron microscopy (SEM) images of prepared microcapsules; (b) shows the diameter of the microcapsules prepared in this invention; and (c) shows a shell-core structure. Images are of the microcapsules of Example 1.

FIG. 3 shows SEM images of both the: (a) outer; and (b) inner shell structure of an individual microcapsule at high magnification; and (c) shell thickness. Images are of the microcapsules of Example 1.

FIG. 4 shows the DSC curves for the durability testing of titania MEPCM microcapsules after running 100 heating-cooling cycles.

FIG. 5 shows: (a) shows the photo spectrum of Rhodamine B at different stages of photocatalysis with titania-MEPCM; and (b) that Rhodamine B molecules, which are not mixed with titania-MEPCM, are completely intact even after 4 hrs visible light irradiation.

FIG. 6 depicts a DSC measurement for the cement mixtures of Example 5 below.

FIG. 7 depicts the photocatalytic decomposition of RhB on the surface of a cement surface that incorporates microcapsules under irradiation of visible light.

FIG. 8 shows XPS peaks associated with Example 1.

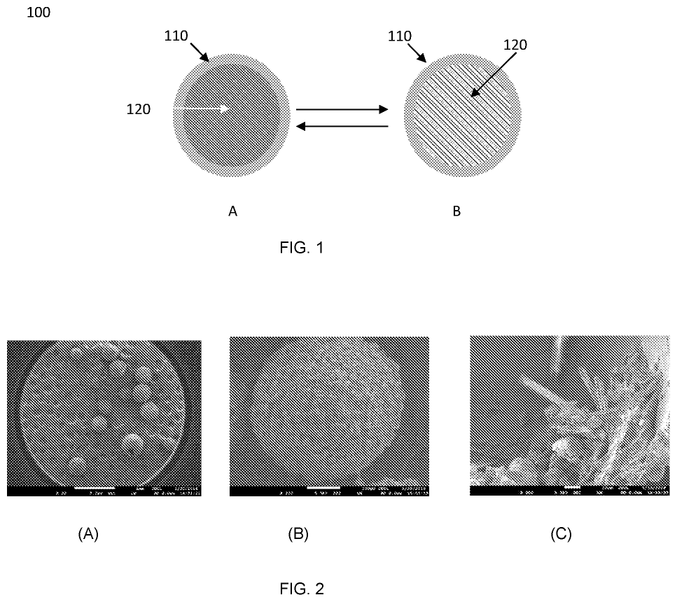

### DESCRIPTION

The invention of phase change materials (PCMs), which are a remarkable temperature-adjusting genus, that are microencapsulated combined with the potential applications of such materials in temperature-adjusting cool paint coatings, is an innovative approach developed to contribute to energy saving and sustainable development. Microencapsulated phase change materials (MEPCMs) can be mixed into paints and cement to form building coatings which provide an efficient way for energy storage and release. MEPCMs coatings play the role of temperature-adjusting in two ways. On the one hand, MEPCMs microcapsules act as obstacles for the heat to pass through. As a result, the indoor temperature would not be too high in the summer daytime which would have been otherwise accomplished by air conditioner. Through this way, the MEPCMs microcapsules reduce the usage of air conditioner in the summer and thus reduce the energy needed to maintain the indoor temperature at a comfortable level. On the other hand, when the surrounding temperature drops at night, MEPCMs microcapsules, which store heat energy, will release heat to the surrounding to adjust the indoor temperature to a comfortable level. Consequently, appreciable energy can be saved. It is expected that MEPCMs microcapsules-mixed coating layers could save more than 15% energy consumed in building cooling and heating.

In a PCM microcapsule, the shell should provide strong protection to ensure that the phase change material does not leak out. This invention fabricates a kind of new TiO₂ polymeric hybrid microcapsule with good mechanical properties and high durability for use in energy saving and releasing processes. In addition, this TiO₂ polymeric hybrid microcapsule also possesses the capability of photocatalysis under visible light. This advanced TiO₂ polymeric hybrid microcapsule can work as an energy storage unit and photocatalyst as well. The combination of the functions can expand the microcapsules' usage into previously unworkable areas, such as in a building's façade.

In order to overcome the problems mentioned above, a dual shell structure was developed in this invention comprising an outer shell of an inorganic material and an inner shell of an organic polymeric material (e.g. a TiO₂-polyurea dual shell structure) to encapsulate a PCM. Thus, there is disclosed a microcapsule encapsulating a phase change material comprising: a core encapsulated by a first shell and a second shell, where the first shell is sandwiched between the second shell and the core, wherein: the core comprises a phase change material that undergoes a phase change at from 0° C. to 200° C.; the first shell is an organic polymeric material; and the second shell comprises a doped titanium dioxide.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

PCMs that can be used herein include various organic and inorganic substances. Examples of PCMs include, but are not limited to, hydrocarbons (e.g., straight-chain alkanes or paraffinic hydrocarbons, branched-chain alkanes, unsaturated hydrocarbons, halogenated hydrocarbons, and alicyclic hydrocarbons), hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils, water, fatty acids, fatty acid esters, dibasic acids, dibasic esters, 1-halides, primary alcohols, secondary alcohols, tertiary alcohols, aromatic compounds, clathrates, semi-clathrates, gas clathrates, anhydrides (e.g., stearic anhydride), ethylene carbonate, methyl esters, polyhydric alcohols (e.g., 2,2-dimethyl-1,3-propanediol, 2-hydroxymethyl-2-methyl-1,3-propanediol, ethylene glycol, polyethylene glycol, pentaerythritol, dipentaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), sugar alcohols (erythritol, D-mannitol, galactitol, xylitol, D-sorbitol), polymers (e.g., polyethylene, polyethylene glycol, polyethylene oxide, polypropylene, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyesters produced by polycondensation of glycols (or their derivatives) with diacids (or their derivatives), copolymers, such as polyacrylate or poly(meth)acrylate with an alkyl hydrocarbon side chain or with a polyethylene glycol side chain and other copolymers that may include monomer units selected from the group including ethylene, ethylene glycol, ethylene oxide, propylene, propylene glycol, or tetramethylene glycol), metals, and mixtures thereof.

The selection of a PCM is typically dependent upon the transition temperature that is desired for a particular application that is going to include the PCM. The transition temperature is the temperature or range of temperatures at which the PCM experiences a phase change from, for example, solid to liquid or liquid to solid. For example, a PCM having a transition temperature near room temperature or normal body temperature can be desirable for clothing applications. A phase change material according to some embodiments of the invention can have a transition temperature in the range of about 0° C. to about 200° C. In other embodiments of the invention, the transition temperature may be from 5° C. to 150° C., such as from 15° C. to 100° C. or from 30° C. to 75° C.

Paraffinic PCMs may be a paraffinic hydrocarbon, that is, hydrocarbons represented by the formula OₙHₙ₊₂, where n can range from about 10 to about 46 carbon atoms, such as from 14 to 45 carbon atoms. PCMs useful in the invention include paraffinic hydrocarbons having 13 to 28 carbon atoms. Specific paraffinic hydrocarbons that may be used in embodiments of the invention are listed below in Table 1, along with their melting point.

TABLE 1

| | Number of Carbon | |
|---|---|---|
| Compound Name | Atoms | Melting Point (° C.) |
| n-Octacosane | 28 | 61.4 |
| n-Heptacosane | 27 | 59.0 |
| n-Hexacosane | 26 | 56.4 |
| n-Pentacosane | 25 | 53.7 |
| n-Tetracosane | 24 | 50.9 |
| n-Tricosane | 23 | 47.6 |
| n-Docosane | 22 | 44.4 |
| n-Heneicosane | 21 | 40.5 |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |

Methyl ester PCMs may be any methyl ester that has the capability of absorbing or releasing thermal energy to reduce or eliminate heat flow within a temperature stabilizing range. Examples of methyl esters that may be suitable for use in embodiments of the current invention, include, but are not limited to methyl palmitate, methyl formate, methyl esters of fatty acids such as methyl caprylate, methyl caprate, methyl laurate, methyl myristate, methyl palmitate, methyl stearate, methyl arachidate, methyl behenate, methyl lignocerate and fatty acids such as caproic acid, caprylic acid, lauric acid, myristic acid, palmitic acid, stearic acid, arachidic acid, behenic acid, lignoceric acid and cerotic acid; and fatty acid alcohols such as capryl alcohol, lauryl alcohol, myristyl alcohol, cetyl alcohol, stearyl alcohol, arachidyl alcohol, behenyl alcohol, lignoceryl alcohol, ceryl alcohol, montanyl alcohol, myricyl alcohol, and geddyl alcohol.

In embodiments of the invention mentioned herein, the phase change material may be an organic phase change material. In particular embodiments that may be mentioned herein the PCM may be a paraffinic PCM, such as octadecane. The PCM may comprise from 50 to 85 wt % of the entire weight of the microcapsule (e.g. from 65 to 80 wt %, such as 75 wt % of the microcapsule).

Paraffin is (or paraffinic hydrocarbons are) a low price commercial product and high latent heat potential organic phase change material. Therefore, its use in this invention can enable the fabrication of the microencapsulated PCMs to be reasonably and easily scaled up.

As mentioned herein, the microcapsule shells are formed from a unique dual-shell structure that is strong and flexible, where the inner shell (i.e. first shell) is formed from an organic polymeric material and the outer shell (i.e. second shell) is formed from a doped titanium dioxide (TiO₂) material. The second shell may be formed from a layer of the doped titanium dioxide having a thickness of from 0.5 μm to 50 μm (e.g. from 1 μm to 10 μm).

Unless otherwise stated the sizes, thicknesses and diameters mentioned herein may be measured using ImageJ software based upon a suitable image of the microcapsule, such as a scanning electron microscope image.

Suitable dopants of the titanium dioxide shell include but are not limited to one or more of the group selected from C, N, F, P, S, I, La, Ce, Er, Pr, Gd, Nd, Sm, V, Fe, Ni, Zn, Os, Ru, Mn, Cr, Co, and Cu. For example, the titanium dioxide shell may be doped with one or more of the group selected from C, N, and F. In particular embodiments of the invention that may be mentioned herein, the titanium dioxide shell comprises one or more areas consisting of a TiO₂₋ₓFₓ structure and/or one or more areas consisting of a TiOF₂ structure. It will be appreciated that the dopants may arise from the manufacture of the TiO₂ material and as such, only certain portions of the second shell may display a TiO₂₋ₓFₓ structure or a TiOF₂ structure when a fluorine-containing precursor has been used to manufacture the TiO₂, while the remaining areas may display a TiO₂ structure and may or may not incorporate a dopant.

In certain embodiments that use fluorine as a dopant, the first and second shell together may comprise, when measured by XPS: an amount of carbon of from 2 to 40 wt %; an amount of nitrogen of from 2 to 10 wt %; an amount of fluorine of from 8 to 18 wt %; an amount of oxygen of from 17 to 50 wt %; an amount of titanium of from 15 to 45 wt %; and the balance hydrogen or other elements. For example, the first and second shell together comprise, when measured by XPS: an amount of carbon of from 11 to 15 wt %; an amount of nitrogen of from 6 to 10 wt %; an amount of fluorine of from to 10 to 15 wt %; an amount of oxygen of from to 32 to 40 wt %; an amount of titanium of from to 28 to 35 wt %; and the balance hydrogen or other elements. For example, the first and second shell together may comprise, when measure by XPS: an amount of carbon of 12.90 wt %; an amount of nitrogen of 6.98 wt %; an amount of fluorine of 12.81 wt %; an amount of oxygen of 35.67 wt %; an amount of titanium of 30.62 wt %; and the balance hydrogen or other elements.

The TiO₂ polymeric hybrid microcapsules described herein, include a polymeric polymer capsule (inner or first shell) that provides a network with high toughness and a skeleton for the TiO₂ nanoparticles to grow on. The inorganic TiO₂ assembles tightly and forms a densely sealed hard shell. The polymer shell improves the toughness property and may include but is not limited to the foregoing example of polyurea (other examples may include polyurea formaldehyde, melamine formaldehyde, a polyamide and a modified polystyrene (see hereinbelow)), while the inorganic shell improves the mechanical strength and impermeability. The hybrid TiO₂-polymeric microcapsule combines these two remarkable properties together successfully.

As alluded to above, any suitable polymeric network may be used to provide the inner (or first) shell of the hybrid microcapsules described herein. Suitable organic polymeric materials generally comprise functional groups that are cationic in aqueous media. When used herein the term “functional groups that are cationic in aqueous media” refers to a functional group in an organic molecule that may carry a positive charge over a range of pH values when in an aqueous environment (e.g. from pH 1.0 to pH 10.0, such as from pH 1.5 to pH 8.0 or from pH 2.0 to pH 7.0, such as from pH 2.5 to 4.0, such as 3.0). For example, the organic polymeric material comprises a polymer selected from the group consisting of a polycationic polymeric material or a polymeric material having an anionic surface that is coated with a polycationic electrolyte. The first shell may have a thickness of from 75 to 250 nm (e.g. from 100 to 200 nm).

Suitable organic polymeric materials which comprise functional groups that are cationic in aqueous media include but are not limited to polyurea, gelatine, chitosan, polyethylenimine, poly(L-lysine), polyamidoamine, poly(amino-co-ester)s, and poly[2-(N,N-dimethylamino)ethyl methacrylate] and copolymers thereof. For example, the polycationic polymeric materials that may be mentioned herein include, but are not limited to, a polyurea (e.g. a polyurea formed from a polyimine and an organic diisocyanate), melamine-formaldehyde resin, urea-formaldehyde resin, and poly(ethylene glycol-co-chitosan) and mixtures thereof.

A particular organic polymeric material that may be mentioned herein may be a polyurea, for example a polyurea formed from a polyimine and an organic diisocyanate. In certain embodiments of the invention, the polyurea may be formed by the reaction between hexamethylene diisocyanate and polyethyienimine. In such embodiments, the weight average molecular weight of the polyethyienimine may be from 800 Daltons to 3,000 Daltons, such as from 1,000 Daltons to 2,000 Daltons, such as 1,300 Daltons.

Suitable polymeric materials having an anionic surface may be selected from the group including, but not limited to, an acrylic-based polymer comprising free carboxylic acid functional groups (e.g. poly(methyl methacrylate) comprising from 1-20% methacrylic acid monomers), a poly(ethylene glycol-co-cellulose) surface-modified with carboxylic acid functional groups, a polystyrene surface-modified with carboxylic acid functional groups, and cyclic poly(phthalaldehyde) (cPPA) surface-modified with carboxylic acid functional groups.

In order for such anionic polymers to work in attracting the negatively charged precursor compounds and/or forming a TiO₂ network, these anionic polymeric materials are coated in a polycationic electrolyte, which binds to the surface of the anionic polymeric material by charge-attraction and in turn binds the TiO₂ materials (and precursors) by the same mechanism. Suitable polycationic electrolytes may be selected from the group that includes, but is not limited to, polyethyleneimine (PEI), poly-L-lysine (PLL), diethylaminoethyl-dextran (DEAE-dextran), and branched polymers such as poly(amidoamine) (PAMAM) dendrimers.

The microcapsules have an average size of from 10 μm to 1000 μm, such as from 50 to 500 μm, from 75 μm to 450 μm, or such as from 100 to 400 μm.

The microcapsules disclosed herein are designed to increase the thermal conductivity, durability and cleanliness of a substrate (e.g. a building or other structure) to which they are ultimately applied to. As a non-limiting example of an application, cooling and self-cleaning paint coatings can be manufactured by dispersing the PCM-filled microcapsules into a commercial paint coating, and the resulting cool-paint coating displays good temperature-adjusting performance as well as self-cleaning properties. Thus, there is also disclosed a paint formulation, a plaster composition, a gypsum composition, a cement composition or a concrete composition, each composition comprising a microcapsule encapsulating a phase change material as disclosed hereinbefore.

When used herein “a plaster composition” refers to any plaster compositions that exclude gypsum as a main constituent. Examples of suitable plasters in accordance with the current invention include lime plaster, cement plaster and heat-resistant plasters.

When used herein, “a gypsum composition” refers to any composition or material where gypsum forms a significant portion of the material. As such, the term may cover gypsum board, drywall and plasterboard (when the plasterboard comprises gypsum).

Furthermore, in order to benefit from the temperature-adjusting capacity of the PCM-encapsulated microcapsules disclosed herein, the microcapsule-based phase change material may be distributed (e.g. randomly dispersed) throughout a host commercial paint matrix, and the resulting mixed functional paint can be applied (e.g. by brushing) onto the wall of a building. During daytime, the function of capsules in the coating is triggered, such that the PCM absorbs the heat and the core-material PCM phase status changes from solid to liquid, thereby inhibiting heat transfer, which would otherwise have gone through the wall into the interior of the building resulting in an increase in temperature. At night, when the ambient temperature reduces gradually, the PCM phase status changes from liquid to solid, and hence, heat will be released to the surroundings, including into the interior of the building.

Therefore, the MEPCMs microcapsules act as a smart temperature-adjusting material due to its reversible phase change function and durability. That is, during the phase change period, the inorganic TiO₂ capsule shell acts as a robust container and protects the PCMs from leaking out and so maintains the whole constant enthalpy of the microcapsules. As will be appreciated, the currently disclosed microcapsules also allow controllable efficiency of thermal conductivity by adjusting the core-shell ratio and shell thickness. Thus, the microcapsules described herein can be randomly dispersed in paint, wet cement and wet concrete in order to yield cool-paint coatings, cement and concrete, which can be used for adjusting and/or controlling the temperature of a building (or a room therein) in a cost-effective and durable manner.

When used herein, “formulation” or “composition” (which may be used herein interchangeably) may be used to refer to a product in a state with or without a solvent present. For example, when applied to a “paint formulation” or “paint composition”, the formulation covers a paint formulation containing a solvent to enable it to be applied to, for example, a wall, but it also covers the dried formulation following application to said wall. The same holds true for other formulations mentioned herein, such as plaster compositions, gypsum compositions, cement formulations and concrete formulations.

As noted herein before, the microcapsules and compositions comprising said microcapsules disclosed herein have self-cleaning properties. As such, when compositions comprising the microcapsules disclosed herein are applied to a surface, it is possible to clean the surface of a foreign material simply by applying visible light to said surface. This is particularly useful in an indoor location (e.g. the inside of a container), as while TiO₂ is known to provide self-cleaning effects on the outside of a building due to ultraviolet light, it has not been used in such a manner to passively clean the inside of a building where a source of ultraviolet light is not readily available (unless specifically provided). As such, the current invention provides self-cleaning compositions that when applied to indoor surfaces, enable said surfaces to self-clean by the simple and convenient application of indoor light (e.g. from conventional lighting apparatus, such as common lightbulbs and the like).

When used herein “foreign materials” refers to a material that is in contact with a surface coated with the microencapsulated materials disclosed herein and may refer particularly to a material that is susceptible to photooxidation in the presence of TiO₂. Such materials may include organic materials and bacterial organisms, amongst other things. As such, the materials have anti-bacterial properties.

In a similar manner to that described above, a composition comprising the microcapsules described herein (or a surface made using a composition comprising said microcapsules) may be used to remove impurities from air (i.e. scrub the air). Again, this process relies on contacting the air (which may comprise foreign materials) with said composition (whether on a surface or in an air scrubbing formation) and exposing said composition to visible light. The resultant photooxidation may remove some or all of the impurities within the air in contact with the composition comprising the microcapsules described herein. Again, this method may be particularly useful in an indoor environment where impurities (e.g. organic molecules) may leach into the air from various sources (e.g. from cooking, smoking or from furniture).

According to another aspect of the present invention, this invention also discloses a method to facilely encapsulate phase change materials (PCMs) into TiO₂ hybrid microcapsules via an interfacial polymerization reaction and electrostatic force in an oil-in-water emulsion. Paraffin is a low price commercial product and high latent heat potential organic phase change material, therefore, this invention can be reasonably and easily scaled up for mass fabrication. The microcapsules are applicable to any matrix materials into which the microcapsules can be dispersed, so this invention can be used to manufacture a broad range of materials that possess temperature-adjusting function. Specifically, this invention is also applied for energy saving applications.

Also disclosed herein is a method that provides a facile way for encapsulating different types of PCMs with TiO₂, including but not limited to paraffinic hydrocarbons as discussed herein before (e.g. octadecane), where the range of melting temperature of the PCM may range from 0° C. to 200° C. (e.g. from 5° C. to 150° C.). This method is a process of making a microcapsule encapsulating a phase change material as defined hereinbefore, comprising the steps of:
(a) providing an aqueous emulsion comprising a first polymeric precursor material, a phase change material and a surfactant;
(b) adding a second polymeric precursor material to the aqueous emulsion to form polymeric pre-microcapsules having a core comprising the phase change material and an organic polymeric shell, through the reaction of the first and second polymeric precursor materials together in a polymerisation reaction; and
(c) adding an inorganic monomeric material to the polymeric pre-microcapsules to form an inorganic shell around each polymeric pre-microcapsule under conditions that cause polymerisation of the inorganic monomeric material to provide a microcapsule encapsulating a phase change material, wherein:
the conditions of step (c) cause self-assembly of the inorganic shell on the organic polymeric shell due to attractive electrostatic interactions between the organic polymeric shell and the inorganic monomeric material;
the phase change material undergoes a phase change at from 0° C. to 200° C.; and
the inorganic monomeric material comprises a titanium dioxide precursor material.

Thus, the process enables a specific PCM (from those described hereinbefore), as the core material, to be encapsulated into a dual shell microcapsule via an interfacial polymerization reaction and electrostatic force in an oil-in-water emulsion system. The outer shell is an inorganic TiO₂, while the inner shell is made from an organic polymeric material as described hereinbefore. During the formation of the microcapsule, the organic polymeric material may be cationic and the TiO₂ precursor material and/or the forming TiO₂ network may be anionic (or vice versa), which enables that electrostatic force between oppositely charged molecules play an important role in the formation of the capsule shell. That is, the positively charged and negatively charged molecules in the reaction mixture are attracted to one another via electrostatic force to form a new shell covering the existing inner organic polymeric capsule.

Without wishing to be bound by theory, it is believed that the formation of the oil-in-water emulsion system affects the ultimate size of the microcapsules obtained, as the stirring/agitation of the emulsion plays a role in determining the size of the emulsion droplets (a core of PCM surrounded by the first polymeric precursor material). This can be inferred from the worked examples provided hereinbelow. Given this, the aqueous emulsion comprising a first polymeric precursor material that is water-immiscible, a phase change material and a surfactant may be provided by:
(I) providing an aqueous solution of a surfactant under stirring at a stirring speed of from 200 to 4000 RPM (e.g. from 400 to 2000 RPM, such as 600 to 2000 RPM); and
(II) providing a mixture of the first polymeric precursor material and the phase change material and adding it to the stirred aqueous solution of the surfactant to form an emulsion.

These agitation conditions may also provide the organic polymeric shell with a thickness of from 75 to 250 nm (e.g. from 100 to 200 nm). For example, when the pre-microcapsule is formed in step (b) by a polyurea formed from hexamethylene diisocyanate and polyethyienimine with a weight average molecular weight of 1,300 Daltons, a speed of 600 RPM in the process of steps (I) and (II) may correspond to the eventual production of microcapsules having an average size of 500 μm, a speed of 1,200 RPM in steps (I) and (II) may correspond to the eventual production of microcapsules having an average size of 100 μm, and a speed of 2,000 RPM in steps (I) and (II) may correspond to the eventual production of microcapsules having an average size of 50 μm.

It will be appreciated that step (II) may be conducted at ambient temperature, but may also be conducted at an elevated temperature, such as a temperature suitable for causing a polymerisation required in step (b). For example, step (II) may be conducted at a temperature of from 30 to 60° C., such as 50° C. Alternatively, step (II) may be conducted at ambient temperature and the resulting emulsion may then be heated up to a suitable temperature to enable the reaction required in step (b) to be conducted (e.g. 30 to 60° C., such as 50° C.).

The phase change material may comprise from 50 to 85 wt % of the finally-produced microcapsule by weight (e.g. from 65 to 80 wt %, such as 75 wt % of the microcapsule).

A suitable surfactant that may be mentioned herein for use in the process described above may be a non-ionic surfactant. Suitable non-ionic surfactants that may be mentioned in embodiments of the invention include, but are not limited to, arabic gum polyethylene oxide lauryl ether 30, sorbitan oleate, sorbitan 80, and polyoxyethylene sorbitol monooleate 80 mixture and combinations thereof. The non-ionic surfactant may act as an emulsifying agent.

The first and second polymeric precursor materials mentioned in the process above may react together to provide an organic polymeric material comprising functional groups that are cationic in aqueous media. The functional groups may be cationic at a pH as described hereinbefore (e.g. they may be cationic at a pH of from 2.0 to 6.0, such as from 2.5 to 4.0, such as 3.0). The first polymeric precursor material may be an organic diisocyanate and the second polymeric precursor material may be a polyimine that react together to provide a polyurea. For example, the first polymeric precursor material may be hexamethylene diisocyanate and the second polymeric precursor material may be a polyethyienimine (e.g. the weight average molecular weight of the polyethyienimine is from 800 Daltons to 3,000 Daltons, such as from 1,000 Daltons to 2,000 Daltons, such as 1,300 Daltons).

In alternative embodiments, the first and second polymeric precursor materials may be ones in which:
(AA) the first polymeric precursor material is melamine and the second polymeric precursor material is a formaldehyde;
(BB) the first polymeric precursor material is an organic diisocyanate and the second polymeric precursor material is a formaldehyde;
(CC) the first polymeric precursor material is ethylene oxide and the second polymeric precursor material is a chitosan.

In yet further alternative embodiments, the first polymeric precursor material may comprise a mixture of an acrylic acid and an alkyl acrylate monomer (e.g. methyl methacrylate) and the second polymeric precursor material may be a radical initiator, which process further comprises after step (b) and before step (c), adding a polycationic electrolyte to the polymerised material to form a polycationic electrolyte coating layer on the surface of the organic polymeric shell.

In still further alternative embodiments of manufacture:
(i) the first polymeric precursor material is ethylene oxide and the second polymeric precursor material is a cellulose acetate;
(ii) the first polymeric precursor material is styrene and the second polymeric precursor material is a radical initiator; or
(iii) the first polymeric precursor material is phthalaldehyde and the second polymeric precursor material is an acid or a base; and
which process further comprises after step (b) and before step (c) of the main process, the steps of:
(aaa) grafting carboxylic functional groups onto the surface of the organic polymeric shell to form an anionic surface; and
(bbb) adding a polycationic electrolyte to the anionic surface of the organic polymeric shell.

In embodiments of the invention that may be mentioned herein, the inorganic monomeric material is a titanium dioxide precursor (e.g. (NH₄)₂TiF₆).

Under the process described herein, the inorganic shell that is deposited may comprise a layer of polymerised TiO₂ material having a thickness of from 0.5 μm to 50 μm (e.g. from 1 μm to 10 μm). The polymerised inorganic monomeric material may be doped by materials present in its formation, such as fluorine and nitrogen as discussed hereinbefore.

The average size (i.e. diameter) of the microcapsules provided in step (c) of the process above may be from 10 to 1000 μm, such as from 50 to 500 μm, from 75 to 450 μm, such as 100 to 400 μm.

In a specific embodiment of the process described hereinbefore, microencapsulation of paraffinic hydrocarbons (and other PCMs) can be realized through an interfacial polymerization reaction between hexamethylene diisocyanate (HDI) and polyethyienimine (PEI) (to form a polyurea) and then a subsequent electrostatic force attraction between the polyurea and a TiO₂ precursor (i.e. monomeric NH₄)₂TiF₆). This may be accomplished by the formation of a surfactant solution (e.g. using an arabic gum aqueous solution) under mechanical agitation at ambient temperature. To this pH-adjusted (and stirred) solution is slowly added in a drop-wise manner an organic solution formed by mixing paraffin (i.e. a paraffinic hydrocarbon) with HDI. The addition of the organic solution to the pH-adjusted solution develops an oil-in-water emulsion solution. The emulsion system can then be heated to a set temperature and the polymerization reaction can then be initiated by the addition of PEI. After stabilization of the organic polymeric material (i.e. the first shell), a titanium dioxide precursor (e.g. NH₄TiF₆) may be added, optionally with H₃BO₃, and the reaction heated for a period of time. The resultant microcapsules are washed using deionized water, filtered and dried for further analysis and application.

In this embodiment, the yield of the microencapsulation process is around 60 wt %, and the core content in the microcapsules is approximately 75 wt %. The resultant microcapsules have an average diameter of 10-1000 μm (e.g. from 50 to 500 μm), depending on the particular reaction conditions used for the preparation. The average diameter of prepared microcapsules is greatly influenced by reaction conditions such as agitation rate.

In order that the invention may be readily understood and put into practical effect, particular embodiments will now be described by way of the following non-limiting examples.

### EXAMPLES

Methods

Images were captured using a scanning electron microscope. The average size of the microcapsules was obtained through measuring the SEM images of the microcapsules by using ImageJ software.

Materials

Arabic gum, hexamethylene diisocyanate (HDI), polyethylenimine (PEI, M_{w}˜1300), octadecane, TiO₂ and hydrochloric acid solution (HCl, 0.1N) were purchased from Sigma Aldrich (Singapore). Aqueous solution of pH=6.0 was prepared using HCl solution. All chemicals were used directly without further purification.

### Example 1

At ambient temperature, 30 ml of deionized water and 0.93 g of a 3 wt % aqueous solution of arabic gum were mixed in a 500 ml beaker. The beaker was suspended in a temperature-controlled water bath on a programmable hot plate with an external temperature probe. The solution was agitated with a digital mixer (Caframo) driving a three-bladed propeller at 800 RPM. To this agitated mixture was slowly added 5 g paraffin (a type of PCM) and 1 g hexamethylene diisocyanate (HDI) to generate an emulsion. After 10 min of emulsification, 10 g of a 1 wt % aqueous solution of polyethylenimine (average Mₙ: 1200, average M_{w}: 1300) was added drop wise into the emulsion under agitation at 150 RPM (any suitable speed, such as from 150 RPM to 800 RPM may be used in this step) and at the same time the reaction mixture was heated to 50° C. at a heating rate of 5° C. per minute. The mixture was then aged 2 hours under agitation. Subsequently, both the stirrer and hot plate were switched off and the resultant pre-microcapsules were washed with deionized water three times (about 100 ml each time) using a separating funnel. After washing, the treated pre-microcapsules were re-dispersed into a 500 ml beaker which was loaded with 30 ml of deionised water.

Subsequently, an aqueous solution of (NH₄)₂TiF₆ (40 mL at 0.5 M) and an aqueous solution of H₃BO₃ (120 mL at 0.5 M) were slowly added into the pre-microcapsules solution. After reaction at 50° C. for 5 hours, the reaction was terminated. The final microcapsule product was collected and washed with deionized water three times (about 100 ml each time) and collected for air-drying at room temperature in fume hood for 24 hours before further analysis.

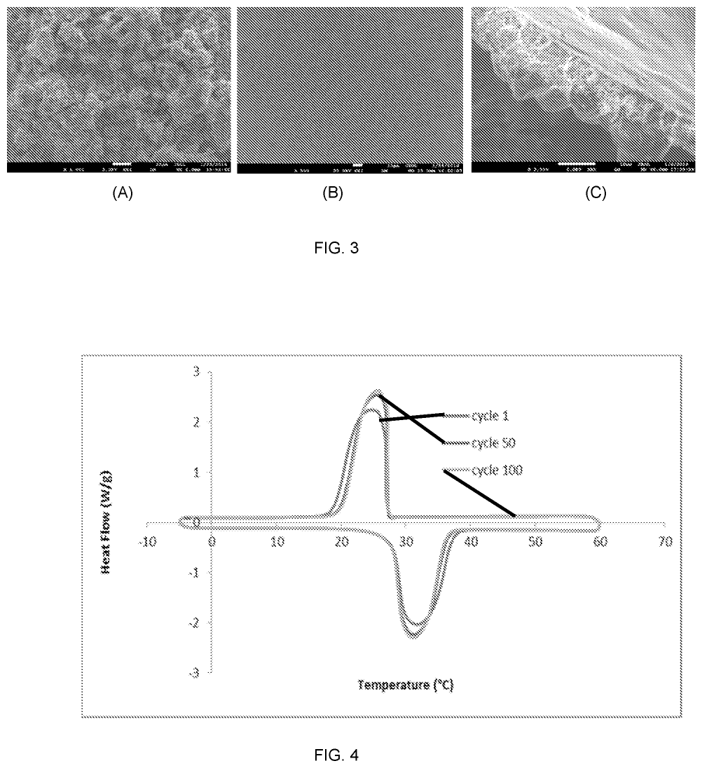

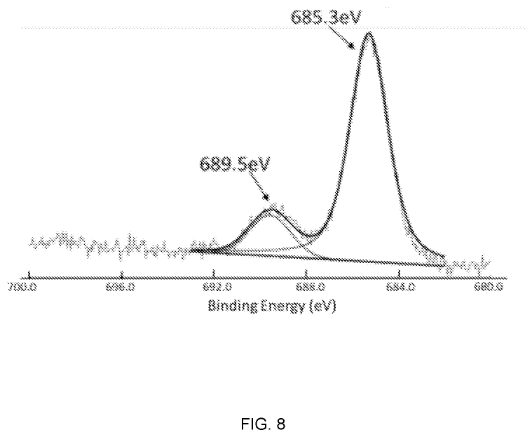

FIGS. 2 and 3 provide SEM images of the microcapsules of Example 1. FIG. 8 shows the XPS peaks associated with Example 1. The peak contribution near 685.4 eV appears to be related to TiOF₂ structures and the peak near 689.5 eV to nonstoichiometric solid solution of F in TiO₂ of the TiO₂₋ₓFₓ type. Analysis of the first and second shell discloses a composition of: 12.90 wt % C, 6.98 wt % N, 12.81 wt % F, 35.67 wt % 0, and 30.62 wt % Ti, with the balance hydrogen.

### Example 2

The procedure of Example 1 was repeated exactly as described above, except that the agitation speed of 800 RPM, was replaced by an agitation speed of 1200 RPM.

### Example 3

The procedure of Example 1 was repeated exactly as described above, except that the agitation speed of 800 RPM, was replaced by an agitation speed of 1500 RPM.

### Example 4

Long-Term Performance Assessment of MEPCMs

The collected TiO₂ MEPCMs in white powder form were prepared in accordance with Example 3. 5 mg of the microcapsules was taken using a precision balance as a sample for the characterization of the durability and reliability of capsules by using Differential Scanning calorimetry (DSC) testing, using a ramp rate of 5° C./min over 100 cycles. Subsequently, the TiO₂-MEPCMs were observed by scanning electron microscopy (SEM) to examine the structure and morphology to see if any change to the structure has occurred when compared to the original MEPCMs capsules.

FIG. 4 demonstrates the long term performance of the TiO₂ MEPCMs capsules. After running 100 heating-cooling cycles, the capsules' performance in the 100^{th} cycle is as good as in the 1^{st} cycle, except that the peak becomes narrower and taller. This indicates the resulting TiO₂ MEPCMs capsules have notable thermal stability and anti-fatigue properties due to the dense and well integral capsules, which inhibit leakage of the core-PCM from the capsules. Furthermore, the narrower and taller peaks obtained during the cycles of the DSC test revealed that thermal conductivity elevated after the heating-cooling cycles. It can be concluded that TiO₂ MEPCMs capsules with good durability have been fabricated successfully.

Photocatalysis Assessment

A 150W Xenon arc lamp (Newport, USA) was used for the artificial solar light source. A dichroic mirror was used to control the light waveband so that visible light with a wavelength of from 420 to 630 nm irradiates the solution surface, which is 10 cm below the light source. The microcapsule concentration was 0.25 g/L and the RhB concentration was 0.025 g/L in the solution.

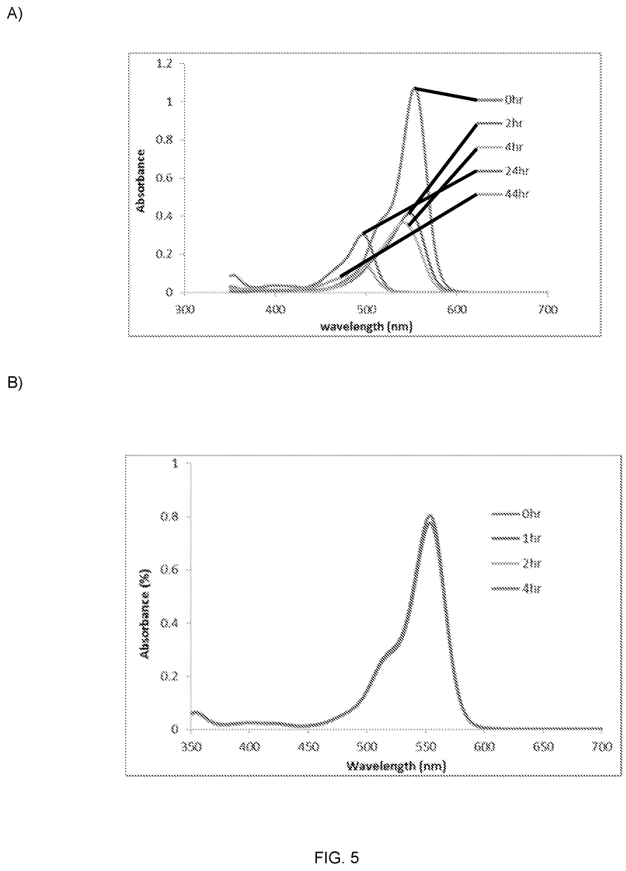

FIG. 5(a) shows the absorbance spectrum of Rhodamine B at different stages of photocatalysis with a titania-MEPCM according to Example 3. The photocatalysis was carried out using a light source that delivered visible light with a wavelength ranging from 420 nm to 630 nm. The characteristic absorbance peak near 550 nm weakened and blue-shifted with time after visible light irradiation, which indicated that the decomposition of Rhodamine B molecules took place with the help of titania-MEPCM. In contrast, FIG. 5(b) shows that Rhodamine B molecules that are not mixed with titania-MEPCM are completely intact even after 4 hrs of visible light irradiation.

### Example 5

Cement Mixtures

White cement from Indocement was used in this experiment. The water to cement ratio was kept at 0.3 (wt/wt) for all mixes.

Mix 1 was a control and only contained the white cement. Mix 2 contained the cement and 10 wt % of TiO₂—PUA MEPCMs (i.e. from Example 3)

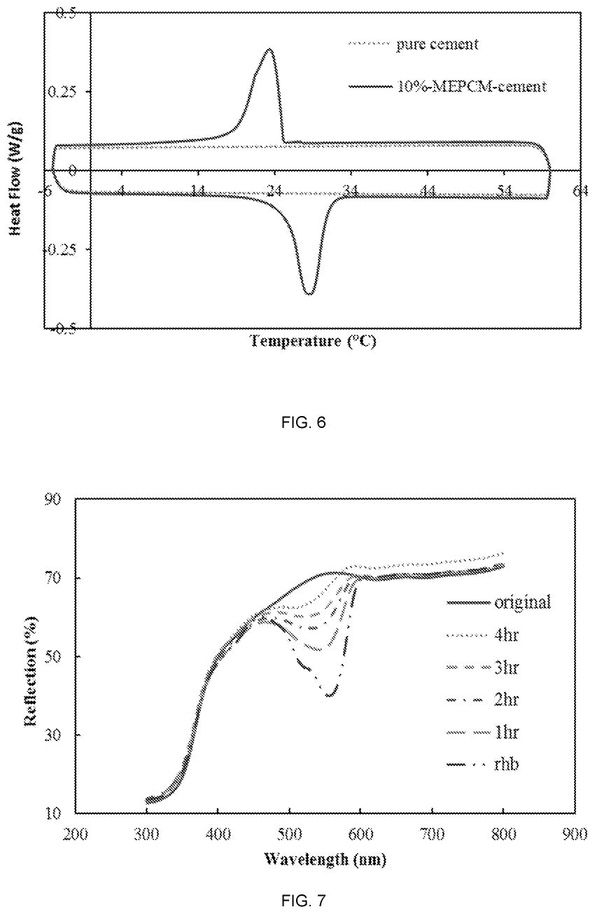

DSC measurement (FIG. 6; conducted in line with Example 4) of mix 1 and mix 2 showed that the phase change behaviour of mix 2 was excellent, while mix 1 showed no change as expected.

The self-cleaning through photocatalysis of TiO₂ in mix 2 was also demonstrated through RhB decomposition under irradiation of visible light as shows in FIG. 7. The self-cleaning experiment was conducted in the same manner as for Example 4, except that the light was shone onto the surface of the cement that had been contaminated with RhB.

1. A microcapsule encapsulating a phase change material comprising:
a core encapsulated by a first shell and a second shell, where the first shell is sandwiched between the second shell and the core, wherein:
the core comprises a phase change material that undergoes a phase change at from 0° C. to 200° C.;
the first shell is an organic polymeric material; and
the second shell comprises a doped titanium dioxide.

2. (canceled)

3. The microcapsule of claim 1, wherein the phase change material is an organic phase change material.

4. The microcapsule of claim 3, wherein the organic phase change material is a C₁₄-C₄₅ paraffinic hydrocarbon.

5. The microcapsule of claim 1, wherein the titanium dioxide shell is doped with one or more of the group selected from C, N, F, P, S, I, La, Ce, Er, Pr, Gd, Nd, Sm, V, Fe, Ni, Zn, Os, Ru, Mn, Cr, Co, and Cu.

6. The microcapsule of claim 5, wherein:
(a) the titanium dioxide shell is doped with one or more of the group selected from C, N, and F; and/or
(b) the titanium dioxide shell comprises one or more areas consisting of a TiO₂₋ₓFₓ structure and/or one or more areas consisting of a TiOF₂ structure.

7. The microcapsule of claim 5, wherein the first and second shell together comprise, when measured by XPS:
an amount of carbon of from 2 to 40 wt %;
an amount of nitrogen of from 2 to 10 wt %;
an amount of fluorine of from 8 to 18 wt %;
an amount of oxygen of from 17 to 50 wt %;
an amount of titanium of from 15 to 45 wt %; and
the balance hydrogen or other elements.

8. The microcapsule of claim 1, wherein the organic polymeric material comprises functional groups that are cationic in aqueous media.

9. The microcapsule of claim 8, wherein the organic polymeric material comprises a polymer selected from the group consisting of a polycationic polymeric material or a polymeric material having an anionic surface that is coated with a polycationic electrolyte.

10. The microcapsule of claim 9, wherein the polycationic polymeric material is selected from the group consisting of a polyurea (e.g. a polyurea formed from a polyimine and an organic diisocyanate), melamine-formaldehyde resin, urea-formaldehyde resin, and poly(ethylene glycol-co-chitosan).

11. The microcapsule of claim 9, wherein:
(a) the polymeric material having an anionic surface is selected from the group consisting of an acrylic-based polymer comprising free carboxylic acid functional groups, a poly(ethylene glycol-co-cellulose) surface-modified with carboxylic acid functional groups, a polystyrene surface-modified with carboxylic acid functional groups, and cyclic poly(phthalaldehyde) (cPPA) surface-modified with carboxylic acid functional groups; and/or
(b) the polycationic electrolyte is selected from the group consisting of polyethyleneimine (PEI), poly-l-lysine (PLL), diethylaminoethyl-dextran (DEAE-dextran), and branched polymers such as poly(amidoamine) (PAMAM) dendrimers.

12. The microcapsule of claim 10, wherein the organic polymeric material comprises a polyurea formed by the reaction between hexamethylene diisocyanate and polyethylenimine.

13. The microcapsule of claim 1, wherein one or more of the following apply to the microcapsule of claim 1:
(i) the microcapsule has an average size of from 10 μm to 1000 μm;
(ii) the first shell has a thickness of from 75 to 250 nm;
(iii) the second shell comprises a layer of the doped titanium dioxide having a thickness of from 0.5 μm to 50 μm;
(iv) the core material comprises from 50 to 85 wt % of the microcapsule; and
(v) the microcapsule is capable of photocatalysis at visible light wavelengths of from 400 nm to 700 nm.

14.-17. (canceled)

18. A composition comprising a microcapsule encapsulating a phase change material as defined in claim 1, wherein the composition is a paint composition, a plaster composition, a gypsum composition, a cement composition or a concrete composition.

19. A process of making a microcapsule encapsulating a phase change material as defined in of claim 1, comprising the steps of:
(a) providing an aqueous emulsion comprising a first polymeric precursor material, a phase change material and a surfactant;
(b) adding a second polymeric precursor material to the aqueous emulsion to form polymeric pre-microcapsules having a core comprising the phase change material and an organic polymeric shell, through the reaction of the first and second polymeric precursor materials together in a polymerisation reaction; and
(c) adding an inorganic monomeric material to the polymeric pre-microcapsules to form an inorganic shell around each polymeric pre-microcapsule under conditions that cause polymerisation of the inorganic monomeric material to provide a microcapsule encapsulating a phase change material, wherein:
the conditions of step (c) cause self-assembly of the inorganic shell on the organic polymeric shell due to attractive electrostatic interactions between the organic polymeric shell and the inorganic monomeric material;
the phase change material undergoes a phase change at from 0° C. to 200° C.; and
the inorganic monomeric material comprises a titanium dioxide precursor material.

20.-24. (canceled)

25. The process of claim 19, wherein the first and second polymeric precursor materials, following reaction together, provide an organic polymeric material comprising functional groups that are cationic in aqueous media.

26. The process of claim 25, wherein one or more of the following apply to the process of claim 25:
(AA) the first polymeric precursor material is an organic diisocyanate and the second polymeric precursor material is a polyimine;
(BB) the first polymeric precursor material is melamine and the second polymeric precursor material is a formaldehyde;
(CC) the first polymeric precursor material is an organic diisocyanate and the second polymeric precursor material is a formaldehyde;
(DD) the first polymeric precursor material is ethylene oxide and the second polymeric precursor material is a chitosan; and
(EE) the first polymeric precursor material comprises a mixture of an acrylic acid and an alkyl acrylate monomer and the second polymeric precursor material is a radical initiator, which process further comprises after step (b) and before step (c), adding a polycationic electrolyte to the polymerised material to form a polycationic electrolyte coating layer on the surface of the organic polymeric shell.

27.-28. (canceled)

29. The process of claim 25, wherein
(i) the first polymeric precursor material is ethylene oxide and the second polymeric precursor material is a cellulose acetate;
(ii) the first polymeric precursor material is styrene and the second polymeric precursor material is a radical initiator; or
(iii) the first polymeric precursor material is phthalaldehyde and the second polymeric precursor material is an acid or a base; and
which process further comprises after step (b) and before step (c), the steps of:
(aaa) grafting carboxylic functional groups onto the surface of the organic polymeric shell to form an anionic surface; and
(bbb) adding a polycationic electrolyte to the anionic surface of the organic polymeric shell.

30.-34. (canceled)

35. The process of claim 19, wherein in step (a) of claim 19, the aqueous emulsion comprising a first polymeric precursor material that is water-immiscible, a phase change material and a surfactant is provided by:
(I) providing an aqueous solution of a surfactant under stirring at a stirring speed of from 200 to 4000 RPM; and
(II) providing a mixture of the first polymeric precursor material and the phase change material and adding it to the stirred aqueous solution of the surfactant.

36.-37. (canceled)

38. A method of self-cleaning a surface made of a composition according to claim 18, said method comprising providing a surface made of a composition according to claim 18 that has been contaminated with a foreign material and exposing said surface to visible light.

39. A method of scrubbing air with a composition comprising microcapsules according to claim 1, said method comprising contacting the composition with air that has been contaminated with a foreign material and exposing the composition to visible light.
